(19) United States
(12) Patent Application Publication
(10) Pub. No.: US 2021/0408702 A1
(43) Pub. Date: Dec. 30, 2021

(54) Outer-Conductor Assembly, Electrical Plug Connector and Electrical Connecting Arrangement

(71) Applicant: Rosenberger Hochfrequenztechnik GmbH & Co., KG, Fridolfing (DE)

(72) Inventor: Willem Blakborn, Inzell (DE)

(21) Appl. No.: 17/346,646

(22) Filed: Jun. 14, 2021

(30) Foreign Application Priority Data
Jun. 24, 2020 (EP) 20181898.6

(51) Int. Cl. H01R 12/58; H01R 13/639; H01R 12/75

(52) U.S. Cl. CPC H01R 12/585; H01R 12/75; H01R 13/639

(57) ABSTRACT

The invention relates to an outer-conductor assembly (6) for an electrical plug connector (2). The outer-conductor assembly (6) has a first interface (9) for the electrical and mechanical contacting of an outer conductor of a corresponding electrical counterpart plug connector and a second interface (10) for the electrical and mechanical contacting of metal-plated recesses (11) of an electrical assembly (3). The second interface (10) has a multiplicity of contact elements (12, 13) for the contacting of the electrical assembly (3). It is provided that a first group of the contact elements is formed as press-in pins (12) for an oversize fit in the metal-plated recesses (11) of the electrical assembly (3), and a second group of the contact elements is formed as resilient contact elements (13) for insertion into the metal-plated recesses (11) of the electrical assembly (3).

### CROSS REFERENCE TO RELATED APPLICATIONS

This Non-Provisional patent application is a United States National Stage patent application which claims the benefit of priority to earlier filed European Patent Application No. 20 181 898.6, which was filed on 24 Jun. 2020. The entire contents of the aforementioned earlier filed European Patent Application is expressly incorporated herein by this reference.

Pursuant to USPTO rules, this foreign priority claim to earlier filed European Patent Application No. 20 181 898.6 is also included in the Application Data Sheet (ADS) filed herewith.

### TECHNICAL FIELD

The invention relates to an outer-conductor assembly for an electrical plug connector, having a first interface for the electrical and mechanical contacting of an outer conductor of a corresponding electrical counterpart plug connector and a second interface for the electrical and mechanical contacting of metal-plated recesses of an electrical assembly.

The invention furthermore relates to an electrical plug connector.

The invention also relates to an electrical connecting arrangement having an electrical plug connector and an electrical assembly, in particular an electrical circuit board.

### BACKGROUND

Various electrical plug connectors are known from the field of electrical engineering. Electrical plug connectors serve, as is known, for transmitting electrical supply signals and/or data signals to corresponding electrical counterpart plug connectors. A plug connector, or counterpart plug connector, may be in particular a plug, a circuit board connector, a panel connector, a socket, or a coupling. The term “plug connector” or “counterpart plug connector” used in the context of the invention is representative of all variants.

High demands are placed in particular on the robustness and reliability of plug connectors for the automotive industry or for vehicles. Accordingly, a plug connection must withstand sometimes high loads, for example mechanical loads, and remain closed in defined fashion, such that the electrical connection is not inadvertently severed for example during the operation of the vehicle. Ensuring reliability is of primary concern in particular in the case of the autonomous operation of vehicles and for driver assistance systems.

In the case of autonomous operation of a vehicle, or in the case of assistance systems being used, it is sometimes necessary for large amounts of data from several cameras, various sensors and navigation sources to be combined with one another and transported, normally in real time. The operation of numerous devices, screens and cameras accordingly requires a high-performance infrastructure in the vehicle electronics system. Accordingly, the demands on the plug connectors and the cable connections within a vehicle with regard to the required data rate have over time become very high. To save structural space and weight, it is furthermore important for plug connectors to be designed to be as compact as possible.

A further demand on plug connectors for the automotive industry consists in that these should be producible economically in high unit quantities and should be easy and reliable to assemble.

An electrical plug connector commonly has an outer-conductor assembly, in particular for electromagnetic shielding of the signal transmission and for the transfer of a reference voltage between a counterpart plug connector and an electrical assembly as a contribution to the signal transmission. Here, the electrical characteristics of the plug connector as a whole, and the usability thereof, for transmitting high-frequency electrical signals, are defined not inconsiderably by the quality of the electromagnetic shielding and in particular the transition resistance between the outer-conductor assembly and the electrical assembly. Whilst a sufficient shielding action can be ensured relatively easily in the region of the first interface for the connection to the corresponding electrical counterpart plug connector and within the electrical plug connector, the continuation of the electromagnetic shielding in the region of the second interface for the connection to the electrical assembly, in particular an electrical circuit board, is often difficult in practice if, at the same time, the suitability of the plug connector for mass production is to be maintained and the outlay for the assembling of the plug connector on the electrical assembly is to be kept low.

The electrical and mechanical contacting between the outer-conductor assembly of the electrical plug connector and the electrical assembly is often realized in practice by means of a so-called oversize fit or “interference fit”. For this purpose, multiple press-in pins of the outer-conductor assembly are pressed with a certain “pressing-in” pressure into associated metal-plated recesses of the electrical assembly. This causes cold welding, and a cohesive connection forms between the press-in pins and the recesses.

However, the maximum “pressing-in” pressure that can be supplied is limited in order to avoid formation of cracks and fractures in the electrical assembly, in particular an electrical circuit board. For this reason, a defined minimum spacing between two adjacent press-in pins should not be undershot. As small a spacing as possible between the press-in pins is however desirable in order to provide a high shielding action and a low transition resistance, in particular if the plug connector is to be used for transmitting high-frequency electrical signals.

In view of the known prior art, it is thus an object of the present invention to provide an outer-conductor assembly which offers a particularly high shielding action, in particular in the transition region to an electrical assembly, and which can be produced economically and assembled easily, preferably in a mass production context.

The present invention is also based on an object of providing an electrical plug connector which offers a particularly high shielding action, in particular in the transition region to an electrical assembly, and which can be produced economically and assembled easily, preferably in a mass production context.

Finally, it is also an object of the invention to provide an improved electrical connecting arrangement which can preferably be advantageously suitable for use in high-frequency technology.

The features described herein concern advantageous embodiments and variants of the invention.

An outer-conductor assembly for an electrical plug connector is provided. The outer-conductor assembly has a first interface for the electrical and mechanical contacting of an outer conductor of a corresponding electrical counterpart plug connector, and a second interface for the electrical and mechanical contacting of metal-plated recesses of an electrical assembly. For the contacting of the electrical assembly, the second interface has a multiplicity of contact elements.

The outer-conductor assembly is preferably of single-part form, though may possibly also be of multi-part form.

The outer-conductor assembly may optionally have, adjoining the first interface, a spring cage for connection to the outer conductor of a corresponding counterpart plug connector.

The outer-conductor assembly is preferably formed entirely from an electrically conductive material. The outer-conductor assembly may however basically also have electrically insulating components, for example seals and/or detent elements composed of plastic. The outer-conductor assembly is preferably designed to electromagnetically shield plug connector components of the electrical plug connector. The outer-conductor assembly is preferably furthermore designed to provide an impedance-controlled electrical transition between the electrical assembly and the counterpart plug connector.

The outer-conductor assembly may be formed partially, substantially or preferably entirely from a metal, preferably a sheet metal.

The first interface may be formed in particular in the region of a “front” end of the outer-conductor assembly or in the region of a front end of the electrical plug connector equipped with the outer-conductor assembly. The second interface may be formed in particular in the region of a “rear” end of the outer-conductor assembly or in the region of a rear end of the electrical plug connector equipped with the outer-conductor assembly. The two interfaces may preferably be arranged at oppositely situated ends (along the longitudinal axis or central axis) of the outer-conductor assembly, or of the electrical plug connector equipped with the outer-conductor assembly.

The outer-conductor assembly is preferably of sleeve-shaped form in order to correspondingly encase plug connector components, which are to be electromagnetically shielded, of the electrical plug connector.

The outer-conductor assembly may have a rectilinear, curved or angled profile, in particular also a right-angled profile for use in an angled plug connector.

It is provided, according to the invention, that a first group of the contact elements is formed as press-in pins (also known under the expression “press-fit pins”) for an oversize fit in the metal-plated recesses of the electrical assembly.

This press-in technique is known in particular as a connecting technique in the field of electrical circuit boards, and has proven successful for producing solder-free electrical connections. In the case of this technique, the outer diameter of the press-in pins is slightly larger than the inner diameter of the metal-plated recesses. The “over-pressing” that arises during the pressing-in process can be accommodated by the deformation in the recess and/or by deformation of the press-in pin. Owing to the action of the force that is built up, a cohesive, cold-welded and gas-tight connection forms.

The use of the oversize fit for the connection of the electrical plug connector to the electrical assembly can be advantageous because, for example, no thermal loading of the components involved occurs. The press-in connections can furthermore be produced very easily and quickly. Furthermore, the gas-tight connection can durably counteract the aging and corrosion of the plug connector.

As already mentioned, it is however a disadvantage of the oversize fit that, naturally, relatively high pressing-in forces are required for the pressing-in operation, which correspondingly subjects the electrical assembly and the outer-conductor assembly to mechanical load during the assembling process. Accordingly, a component-dependent minimum spacing between adjacent contact elements, and thus also a maximum number of contact elements, should not be undershot.

It is proposed, according to the invention, that a second group of contact elements is formed as resilient contact elements for insertion into the metal-plated recesses of the electrical assembly.

The resilient contact elements are preferably designed in the form of angled contact feet or spring tabs. In particular, the resilient contact elements may be angled and protrude laterally at least in certain sections from the outer-conductor assembly.

The resilient contact elements preferably run so as not to be coplanar with the wall of the outer-conductor assembly.

By virtue of the fact that, according to the invention, two different groups of contact elements are provided, wherein the first group has press-in pins for the oversize fit, and the second group has resilient contact elements, the number or the density of contact elements can advantageously be increased without risking assembly-induced damage to or fracture of the electrical assembly, for example of an electrical circuit board. Owing to the increased density of contact elements or the reduction of the minimum spacing between the contact elements, it is ultimately possible for the shielding action of the outer-conductor assembly to be sufficiently increased, and for the transition resistance to be reduced, in order to provide an electrical plug connector for transmitting high-frequency electrical signals. Furthermore, an impedance-controlled transition between the outer-connector assembly and the electrical assembly can be provided.

The outer diameters of the press-in pins are preferably larger than the inner diameters of the metal-plated recesses of the electrical assembly in order to allow the oversize fit.

By contrast, the outer diameters of the resilient contact elements are preferably smaller than the inner diameters of the metal-plated recesses of the electrical assembly. By virtue of the fact that the resilient contact elements can be inserted into the metal-plated recesses without significant expenditure of force, the electrical assembly is relieved of mechanical load. At the same time, the preload of the resilient contact element gives rise to a mechanically and electrically secure connection between the outer-conductor assembly and the electrical assembly.

The press-in pins may, at their free ends, have an insertion section, the outer diameter of which is smaller than the inner diameter of the metal-plated recesses. It may be provided that the cross section of the press-in pin widens proceeding from the insertion section. The insertion of the press-in pin can be facilitated in this way. Furthermore, in this way, the pressing-in pressure required for the pressing of the press-in pin into the recess can increase continuously during the pressing-in process, which can further reduce the mechanical load for the components involved.

It may be provided that the press-in pins are designed to be longer, preferably are designed to be at least 10% longer, particularly preferably are designed to be at least 20% longer, very particularly preferably are designed to be at least 50% longer and even more preferably are designed to be at least 100% longer, than the resilient contact elements.

In one advantageous refinement of the invention, it may be provided that the press-in pins have an elastic deformation zone at least along a section of their longitudinal axis. The deformation zone is preferably formed by a central material recess.

The press-in pins may in particular have an elongate material recess or a slot oriented along the longitudinal axis of the press-in contact, preferably in the manner of the eye of a needle.

It may be provided that the material recess does not extend all the way through the material of the press-in pin but is formed for example merely as a depression or groove, for example also as a depression on both sides.

It is also possible for multiple material recesses to be provided, which are preferably arranged so as to be distributed along the longitudinal axis of the respective press-in pin.

It may also be provided that the press-in pins do not have a deformation zone but are of solid form.

In one refinement of the invention, it may be provided that the second interface is formed on an end section, facing toward the electrical assembly at a face side, of a sleeve-shaped encircling wall of the outer-conductor assembly. Preferably, the contact elements extend from the end section in the direction of the assembly.

Preferably, the contact elements run as an elongation of the wall of the outer-conductor assembly.

The contact elements are arranged preferably in ring-shaped, for example rectangular, oval or circular, form in the region of the second interface.

In one refinement of the invention, it may be provided that the contact elements are arranged so as to be distributed along the periphery of the sleeve-shaped encircling wall. The contact elements are preferably arranged so as to be distributed symmetrically and/or uniformly or equidistantly.

The contact elements may be arranged so as to be distributed preferably axially symmetrically along the periphery. A point-symmetrical arrangement may however also be provided. An equidistant distribution of the contact elements may furthermore be very particularly suitable, wherein a non-equidistant distribution may also be provided in individual cases.

In one refinement of the invention, it may be provided that at least one of the resilient contact elements is, along the periphery of the sleeve-shaped encircling wall, arranged between two press-in pins.

It is however not imperatively necessary for one or more resilient contact elements to be arranged between all adjacent press-in pins—depending on the spacing of the press-in pins to one another.

Basically, a high number of press-in pins is preferred in order to reduce the transition resistance between outer-conductor assembly and electrical assembly, for which reason provision may be made to use more press-in pins than resilient contact elements. In general, it is however possible for any desired number of press-in pins and any desired number of resilient contact elements to be provided. The ratio between the number of press-in pins and the number of resilient contact elements is arbitrary.

It is preferable for two to ten or more resilient contact elements to be provided, furthermore preferably four to eight resilient contact elements, in particular exactly six resilient contact elements. It is however also possible for only a single resilient contact element to be provided.

It is preferable for two to ten or more press-in pins to be provided, particularly preferably four to eight press-in pins, in particular exactly four press-in pins. It is however also possible for only a single press-in pin to be provided.

In one refinement of the invention, it may be provided that the outer-conductor assembly is formed as a single piece, preferably from a stamped and bent part.

The outer-conductor assembly may in particular be formed as a single piece with the contact elements (press-in pins and/or resilient contact elements). It may however also be provided that the outer-conductor assembly and the contact elements are of multi-part form. Production of the outer-conductor assembly as a single piece from a metal sheet can be particularly suitable for mass production.

In one advantageous refinement of the invention, it may be provided that the outer-conductor assembly, in particular the contact elements (press-in pins and/or resilient contact elements) are formed from aluminum bronze.

It is basically possible for the outer-conductor assembly and/or the contact elements to be formed from any metal or any metal alloy, for example from brass, bronze and/or beryllium copper. The inventors have however identified that aluminum bronze can be suitable for a particularly good connection between the electrical plug connector and the electrical assembly.

The surface of the outer-conductor assembly, in particular of the contact elements (press-in pins and/or resilient contact elements), may be blank, nickel-plated, tin-plated, gold-plated and/or palladium-plated.

The invention also relates to an electrical plug connector having an outer-conductor assembly as described herein.

Through the use of the proposed outer-conductor assembly in the plug connector, the setting forces for the assembling of the electrical plug connector on the electrical assembly can advantageously be reduced.

A plug connector according to the invention can advantageously be suitable for transmitting high-frequency electrical signals. The plug connector and the fastening thereof to the electrical assembly can furthermore be of robust and nevertheless compact form.

The electrical plug connector may preferably be in the form of an angled plug connector. The electrical plug connector may however also be of non-angled form.

The electrical plug connector is preferably in the form of a circuit board plug connector (plug or socket) or in the form of a cable plug connector (plug or coupling).

The electrical plug connector may in particular be designed to provide a modular plug connector system, for example an H-MTD plug connector. The electrical plug connector is however not limited to a specific plug connector type, wherein the invention is particularly suitable for plug connectors for high-frequency technology. It may in particular also be, but is not limited to, a plug connector of type PL, BNC, TNC, SMBA (FAKRA), SMA, SMB, SMS, SMC, SMP, BMS, HFM (FAKRA-Mini), BMK, Mini-Coax or MATE-AX.

The plug connector according to the invention may particularly advantageously be used within a vehicle, in particular a motor vehicle. Here, the expression “vehicle” describes any means of transport, in particular vehicles for use on land, on water or in the air, and also includes spacecraft. Possible fields of use are autonomous driving, driver assistance systems, navigation systems, “infotainment” systems, rear-seat entertainment systems, Internet connections and Wireless Gigabit (IEEE 802.11ad standard). Possible applications relate to high-resolution cameras, for example 4K and 8K cameras, sensor arrangements, on-board computers, high-resolution screens, high-resolution dashboards, 3D navigation units and mobile radio units.

The plug connector according to the invention is suitable for any applications within the entire field of electrical engineering, and is not to be understood as being limited to use in automotive engineering. It is however preferable if the electrical plug connector is a purely electrical plug connector and has no optical components.

In one advantageous refinement of the invention, it may be provided that the electrical plug connector has an electrically insulating housing assembly with a mechanical interface for the connection of the electrical plug connector to the corresponding counterpart plug connector.

The mechanical interface may have means for mechanical coding, in particular for ensuring a correct orientation of the plug connector and of the counterpart plug connector and/or for ensuring that only admissible counterpart plug connectors can be mechanically connected to the plug connector.

The mechanical interface may have detent means for detent engagement between the plug connector and the counterpart plug connector.

The mechanical interface may have one or more seals.

The outer-conductor assembly may be received in the housing assembly, preferably in positively locking and/or non-positively locking fashion. A reversed arrangement may however also be provided, in which the housing assembly is received in the outer-conductor assembly, preferably in positively locking and/or non-positively locking fashion.

It may be provided that the outer-conductor assembly projects with an end section out of the housing assembly at a second (rear) end of the housing assembly which is situated opposite the mechanical interface. In this way, a mechanical and/or electrical connection to the electrical assembly (for example a cable, a device housing or an electrical circuit board) can be made possible in a particularly simple manner.

The electrically insulating housing assembly is preferably of single-part form, though may possibly also be of multi-part form. The housing assembly may for example optionally have seals and/or fastening elements.

The housing assembly is preferably formed exclusively from an electrically insulating material. The housing assembly may however basically also have electrically conductive components, for example connecting elements for connecting the plug connector to an electrical circuit board or to a corresponding counterpart plug connector, for example spring tabs, screw elements and/or detent elements.

The housing assembly may be formed partially, substantially or preferably entirely from a plastic.

The outer-conductor assembly may optionally have at least one fastening tab that can be bent from a basic state into a fastening state in order to fasten the outer-conductor assembly to the housing assembly during the course of the plug connector assembling process. By means of the proposed fastening, a solid undercut can be provided between the housing assembly and the outer-conductor assembly. In this way, the housing assembly can be significantly secured on the outer-conductor assembly (or vice versa), preferably such that pulling-off in a forward direction or counter to the plugging-in direction of a corresponding counterpart plug connector is prevented. Alternatively, it is however also possible for some other fastening to be provided between the outer-conductor assembly and the housing assembly, for example an interference fit or a fastening by means of fastening claws.

In one advantageous refinement of the invention, it may be provided that the electrical plug connector has at least one electrical inner-conductor contact element which extends from a first end, arranged within the first interface, to a second end, arranged within the second interface, through the outer-conductor assembly, wherein the inner-conductor contact element is, at its first end, designed for the electrical and mechanical contacting of a corresponding inner conductor of the electrical counterpart plug connector and, at its second end, designed for the electrical and mechanical contacting of a corresponding inner conductor of the electrical assembly.

The electrical plug connector may basically have any number of inner-conductor contact elements, for example also only exactly one inner-conductor contact element. The electrical plug connector however preferably has two to twelve inner-conductor contact elements, in particular two inner-conductor contact elements, four inner-conductor contact elements or eight inner-conductor contact elements.

The housing assembly may possibly be designed to receive more than one outer-conductor assembly, for example two outer-conductor assemblies or more outer-conductor assemblies, three outer-conductor assemblies or more outer-conductor assemblies, four outer-conductor assemblies or even more outer-conductor assemblies. Alternatively or in addition, it may be provided that the at least one outer-conductor assembly is designed to shield multiple inner-conductor contact elements separately from one another. Preferably, the outer-conductor assembly is designed to shield in each case two inner-conductor contact elements jointly from further inner-conductor contact elements that are possibly present.

The electrical plug connector may also have multiple outer-conductor assemblies, for example two or even more outer-conductor assemblies, four or even more outer-conductor assemblies or eight or even more outer-conductor assemblies. It is preferable if each outer-conductor assembly electromagnetically shields exactly two inner-conductor contact elements.

The electrical plug connector may also have further plug connector components aside from the insulating housing assembly and the outer-conductor assembly. For example, it may be provided that the electrical plug connector has one or more insulating parts composed of an electrically insulating material in order to electrically insulate the at least one inner-conductor contact element with respect to the outer-conductor assembly and mechanically fix said at least one inner-conductor contact element within the outer-conductor assembly. The electrical plug connector may basically also have any other desired components, such as seals or fastening elements for fastening to an electrical assembly (for example to a cable or to a circuit board).

In one refinement of the invention, it may be provided that the maximum center-to-center spacing between contact elements which are directly adjacent along the periphery of the sleeve-shaped encircling wall of the second interface corresponds to one quarter of the wavelength of the signal frequency intended for the signal transmission with the electrical plug connector.

The electromagnetic shielding can thus be optimized for the wavelength to be used. The signal frequency intended for the signal transmission with the electrical plug connector may for example be 20 GHz.

It may be provided that the maximum center-to-center spacing between directly adjacent contact elements is 0.5 mm to 4.0 mm, preferably 1.0 mm to 2.0 mm, particularly preferably approximately 1.5 mm, for example 1.6 mm. The center to-center spacing may however also be less than 0.5 mm or greater than 4.0 mm.

The invention also relates to an electrical connecting arrangement, having an electrical plug connector according to any of the disclosures herein and having an electrical assembly, in particular an electrical circuit board, with metal-plated recesses for electrical and mechanical contacting with the second interface of the outer-conductor assembly of the electrical plug connector.

The electrical connecting arrangement according to the invention may preferably be designed as a connecting arrangement composed of an electrical circuit board plug connector and of an electrical circuit board. It is however basically possible for any connecting arrangement composed of an electrical plug connector and of an electrical assembly to be provided, for example also an electrical cable plug connector, which is fastened to an electrical assembly in the form of a cable, or an electrical device plug connector, which is fastened to a device housing of an electrical assembly.

It is advantageously possible for an electrical connecting arrangement to be provided in the case of which the assembling of the electrical plug connector on the electrical assembly can be performed with reduced assembling force. The known oversize fit or press-fit connection can be considerably improved by means of the resilient contact elements proposed according to the invention (which may also be referred to as “contact springs”).

The shielding action in the transition region between the electrical plug connector and the electrical assembly can be improved in accordance with the invention, wherein, at the same time, crack or fracture formation in the circuit board or in the electrical assembly during the assembling process is avoided.

It may be provided that the resilient contact elements are merely inserted into the associated metal-plated recesses counter to an elastic resetting force and are not pressed in, but at the same time, owing to the resetting force in the state in which they have been inserted into the metal-plated recesses, said resilient contact elements exert a corresponding contact pressure on the metal coating of the recesses for a sufficient mechanical and electrical connection.

Preferably, the resilient contact elements and the metal-plated recesses are designed such that the insertion of the resilient contact elements into the recesses results not in cold welding but in a fastening based on elastic preload.

In one advantageous refinement of the invention, it may be provided that the metal-plated recesses are formed as plated through-holes (“vias”) and/or blind bores in the electrical assembly, in particular in the electrical circuit board. A depression may also be provided in the electrical assembly.

The contacting between the resilient contact elements and the metal-plated recesses of the electrical assembly is preferably of radial configuration. In a preferred refinement of the invention, it may thus be provided that the resilient contact elements are designed to make contact with the metal-plated recesses radially against the inner surface thereof under mechanical preload when the resilient contact elements have been inserted into the metal-plated recesses.

If the metal-plated recesses are formed as blind bores or depressions, it is however alternatively or additionally also possible for face-side contacting to be provided.

In one refinement of the invention, it may be provided that the press-in pins, the resilient contact elements and/or the metal-plated recesses have a circular or rectangular cross section. Further (in particular polygonal) cross sections may also be provided.

In particular, a square cross-sectional profile, optionally with rounded corners, may be particularly suitable for forming the press-in pins and/or the resilient contact elements.

In one advantageous refinement of the invention, it may be provided that the diameter of all metal-plated recesses provided for contacting with the outer-conductor assembly is identical.

In this way, the outlay for the production of the electrical assembly or of the circuit board can be further simplified.

Features that have been described in conjunction with one of the subjects of the invention, which are specifically the outer-conductor assembly according to the invention, the electrical plug connector according to the invention and the electrical connecting arrangement according to the invention, can also be advantageously applied to the other subjects of the invention. Likewise, advantages that have been mentioned in conjunction with one of the subjects of the invention can also be understood as relating to the other subjects of the invention.

In addition, it should be noted that expressions such as “comprising”, “having” or “with” do not exclude any other features or steps. Furthermore, expressions such as “a” or “the” that refer in the singular to steps or features do not exclude a plurality of features or steps—and vice versa.

Terms such as “first” or “second” etc. are used predominantly for the sake of distinguishability between respective device or method features, and are not imperatively intended to indicate that features are mutually dependent or relate to one another. Furthermore, the expression part “outer conductor” of the outer-conductor assembly is not to be understood as meaning that an inner conductor or an inner-conductor contact element imperatively has to be provided.

It is furthermore emphasized that the values and parameters described in the present case also encompass deviations or fluctuations of ±10% or less, preferably ±5% or less, more preferably ±1% or less, and very particularly preferably ±0.1% or less, of the respectively stated value or parameter, if such deviations are not ruled out in practice in the implementation of the invention. The specification of ranges by way of start and end values also encompasses all values and fractions encompassed by the respectively stated range, in particular the start and end values and a respective mean value.

The invention also relates to an outer-conductor assembly for an electrical plug connector, having at least one press-in pin for an oversize fit in recesses of an electrical assembly and at least one resilient contact element for pressing into the recesses of the electrical assembly. The features described in the present description relate to advantageous embodiments and variants of this outer-conductor assembly.

Exemplary embodiments of the invention will be described in more detail below with reference to the accompanying Figures.

### SUMMARY

A principal aspect of the present invention is an outer-conductor assembly (6) for an electrical plug connector (2), having a first interface (9) for electrical and mechanical contacting of an outer conductor of a corresponding electrical counterpart plug connector and a second interface (10) for the electrical and mechanical contacting of metal-plated recesses (11) of an electrical assembly (3), wherein the second interface (10) has a multiplicity of contact elements (12, 13) for the contacting of the electrical assembly (3), characterized in that a first group of the contact elements is formed as press-in pins (12) for an oversize fit in the metal-plated recesses (11) of the electrical assembly (3), and a second group of the contact elements is formed as resilient contact elements (13) for insertion into the metal-plated recesses (11) of the electrical assembly (3).

A further aspect of the present invention is an outer-conductor assembly, characterized in that the press-in pins (12) have, at least along a section of their longitudinal axis (L_{E}), an elastic deformation zone which is preferably formed by a central material recess (18).

A further aspect of the present invention is an outer-conductor assembly characterized in that the second interface (10) is formed on an end section, facing toward the electrical assembly (3) at a face side, of a sleeve-shaped encircling wall (20) of the outer-conductor assembly (6), proceeding from which the contact elements (12, 13) extend in the direction of the electrical assembly (3).

A further aspect of the present invention is an outer-conductor assembly characterized in that the contact elements (12, 13) are arranged in distributed fashion, preferably are arranged in symmetrically and/or equidistantly distributed fashion, along a periphery of the sleeve-shaped encircling wall (20).

A further aspect of the present invention is an outer-conductor assembly characterized in that at least one of the resilient contact elements (13) is, along a periphery of the sleeve-shaped encircling wall (20), arranged between two press-in pins (12).

A further aspect of the present invention is an outer-conductor assembly characterized in that the outer-conductor assembly (6) is formed as a single piece, preferably from a stamped and bent part.

A further aspect of the present invention is an outer-conductor assembly characterized in that the outer-conductor assembly (6) is formed from aluminum bronze.

A further aspect of the present invention is an electrical plug connector having an outer-conductor assembly.

A further aspect of the present invention is an electrical plug connector characterized by an electrically insulating housing assembly (4) with a mechanical interface (5) for connection of the electrical plug connector (2) to the corresponding counterpart plug connector, and wherein the outer-conductor assembly (6) is received in positively locking fashion in the housing assembly (4).

A further aspect of the present invention is an electrical plug connector characterized by at least one inner-conductor contact element (14) which extends from a first end (15), arranged within the first interface (9), to a second end (16), arranged within the second interface (10), through the outer-conductor assembly (6), and wherein the inner-conductor contact element (14) is, at its first end (15), designed for the electrical and mechanical contacting of a corresponding inner conductor of the electrical counterpart plug connector and, at its second end (16), designed for the electrical and mechanical contacting of a corresponding inner conductor of the electrical assembly (3).

A further aspect of the present invention is an electrical plug connector characterized in that the maximum center-to-center spacing (D) between contact elements (12, 13) which are directly adjacent along the periphery of the sleeve-shaped encircling wall (20) of the second interface (10) corresponds to one quarter of the wavelength of the signal frequency intended for the signal transmission with the electrical plug connector (2).

A further aspect of the present invention is an electrical connecting arrangement (1), having an electrical plug connector (2) having an electrical assembly, in particular an electrical circuit board (3), with metal-plated recesses (11) for electrical and mechanical contacting with the second interface (10) of the outer-conductor assembly (6) of the electrical plug connector (2).

A further aspect of the present invention is an electrical connecting arrangement characterized in that the metal-plated recesses are formed as plated through-holes (11) and/or blind bores in the electrical assembly, in particular in the electrical circuit board (3).

A still further aspect of the present invention is an electrical connecting arrangement characterized in that the resilient contact elements (13) are designed to make contact radially, under mechanical preload, with the metal-plated recesses (11) at the inner surface thereof when the resilient contact elements (13) have been inserted into the metal-plated recesses (11).

An even still further aspect of the present invention is an electrical connecting arrangement (1), characterized in that the outer diameter of the resilient contact elements (13) is smaller than the inner diameter of the metal-plated recesses (11).

### BRIEF DESCRIPTIONS OF THE FIGURES

The Figures each show preferred exemplary embodiments in which individual features of the present invention are illustrated in combination with one another. Features of one exemplary embodiment may also be implemented separately from the other features of the same exemplary embodiment, and may accordingly be readily combined by an expert to form further useful combinations and sub-combinations with features of other exemplary embodiments.

Elements of identical function are denoted by the same reference designations in the Figures.

In the Figures, in each case schematically:

FIG. 1 shows an electrical connecting arrangement, composed of an electrical plug connector and an electrical assembly, in a perspective illustration.

FIG. 2 shows the outer-conductor assembly of the plug connector of FIG. 1 in a perspective illustration on its own.

FIG. 3 shows an insulating part of the plug connector of FIG. 1 in a perspective illustration on its own.

FIG. 4 shows two inner-conductor contact elements of the plug connector of FIG. 1 in a perspective illustration on their own.

FIG. 5 shows the outer-conductor assembly of FIG. 2 in a plan view of the second interface.

FIG. 6 shows a partial cross section view through an electrical assembly with metal-plated through-holes for receiving press-in pins and resilient contact elements during the assembling of the electrical plug connector on the electrical assembly.

FIG. 7 shows a partial cross section view similar to FIG. 6 after the assembling of the electrical plug connector on the electrical assembly.

FIG. 8 shows a perspective enlarged detail view of two resilient contact elements, and of a press-in pin arranged in between, of the outer-conductor assembly of the plug connector of FIG. 1.

FIG. 9 shows a side detail view of the second interface of the plug connector of FIG. 2.

FIG. 10 shows a rear detail view of the second interface of the plug connector of FIG. 2.

### DETAILED WRITTEN DESCRIPTION OF THE PREFERRED EMBODIMENTS

This disclosure of the invention is submitted in furtherance of the Constitutional purposes of the US Patent Laws “to promote the progress of science and useful arts” (Article 1, Section 8).

FIG. 1 shows an electrical connecting arrangement 1 having an electrical plug connector 2 and an electrical assembly 3. In the exemplary embodiments, the electrical plug connector 2 is in the form of a circuit board plug connector 2 and the electrical assembly 3 is in the form of an electrical circuit board 3. This is however not to be understood as limiting. It is basically possible in the context of the invention for any electrical plug connector 2 and any electrical assembly 3 to be provided. In the exemplary embodiments, the electrical plug connector 2 is in the form of an angled plug connector 2, however, the electrical plug connector 2, may also be in the form of a non-angled or straight plug connector.

The electrical plug connector 2 has an electrically insulating housing assembly 4 with a mechanical interface 5 for the connection of the electrical plug connector 2 to a corresponding counterpart plug connector (not illustrated). The housing assembly 4 is formed as a single piece from a plastic.

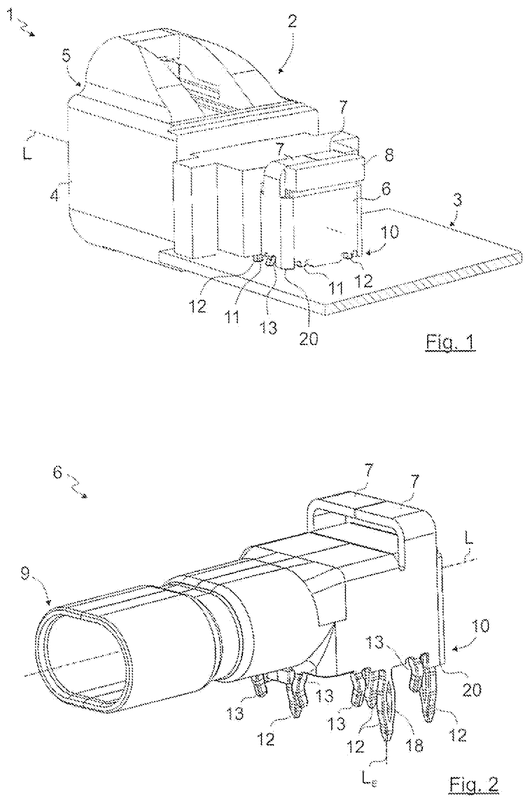

The electrical plug connector 2 furthermore has an outer-conductor assembly 6 which is received in positively locking fashion in the housing assembly 4. For a complete illustration, the outer-conductor assembly 6 is illustrated on its own in FIG. 2.

The fastening between the outer-conductor assembly 6 and the housing assembly 4 is basically arbitrary. In the exemplary embodiment, the outer-conductor assembly 6 has two bendable fastening tabs 7. In their basic state (not illustrated), the fastening tabs 7 are capable of allowing an assembling movement for the assembling of the housing assembly 4 on the outer-conductor assembly 6 along the longitudinal axis L of the housing assembly 4. By contrast, in the bent fastening state illustrated, the fastening tabs 7 are capable of blocking the housing assembly 4 on the outer-conductor assembly 6 in positively locking fashion. For this purpose, the housing assembly 4 has a fastening web 8 (cf. FIG. 1), behind a fastening edge of which the fastening tabs 7 engage.

The outer-conductor assembly 6 has a first interface 9 for the electrical and mechanical contacting of an outer conductor of the corresponding electrical counterpart plug connector. The outer-conductor assembly 6 furthermore has a second interface 10 for the electrical and mechanical contacting of metal-plated recesses 11 (cf. FIGS. 1, 6 and 7) of the electrical assembly or of the circuit board 3. For the contacting of the circuit board 3, the second interface 10 has a multiplicity of contact elements 12, 13.

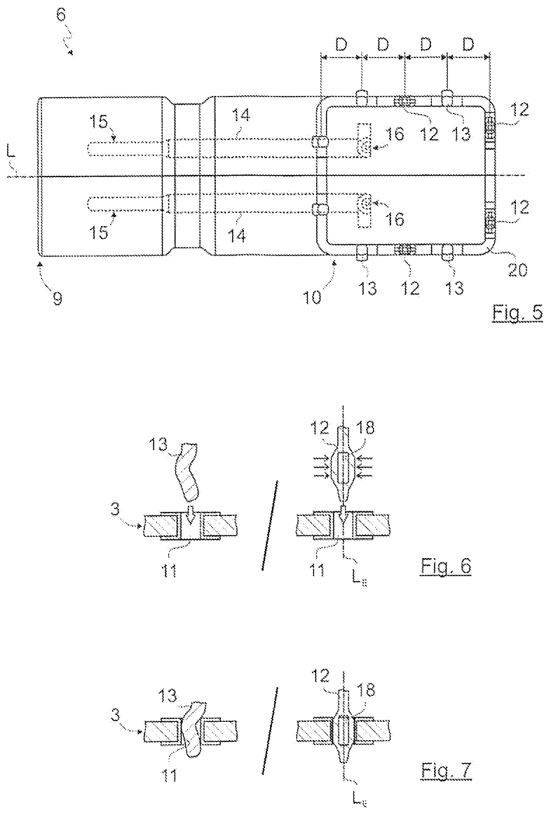

The electrical plug connector 2 preferably has at least one inner-conductor contact element 14. In the exemplary embodiment, the electrical plug connector 2 has exactly two inner-conductor contact elements 14, which are illustrated separately in FIG. 4. The inner-conductor contact elements 14 extend from a first end 15, which is arranged within the first interface 9, to a second end 16, which is arranged within the second interface 10, through the outer-conductor assembly 6 (cf. in particular the illustration in dashed lines in FIG. 5). At its first end 15, the inner-conductor contact element 14 is designed for the electrical and mechanical contacting of a corresponding inner conductor of the electrical counterpart plug connector. At its second end 16, the inner-conductor contact element 14 is designed for the electrical and mechanical contacting of a corresponding conductor/inner conductor of the electrical assembly or of the electrical circuit board 3 (for example of a conductor track or of a plated through-hole).

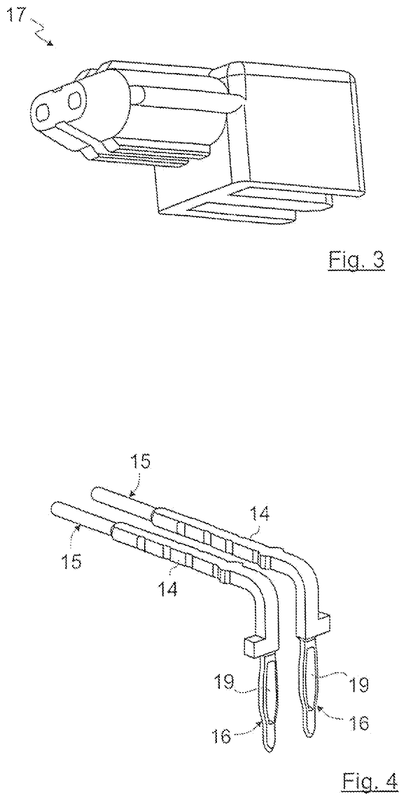

The electrical plug connector 2 may furthermore also have yet further plug connector components. The electrical plug connector 2 of the exemplary embodiment has an insulating part 17 which is received within the outer-conductor assembly 6 and in which the inner-conductor contact elements 14 are individually guided. The insulating part 17 is illustrated on its own, by way of example, in FIG. 3. By means of the insulating part 17, the inner-conductor contact elements 14 can be sufficiently fixed in the electrical plug connector 2 and electrically insulated with respect to the outer-conductor assembly 6.

The outer-conductor assembly 6 may, on the one hand, serve for electromagnetically shielding the inner-conductor contact elements 14. The outer-conductor assembly 6 may furthermore perform the function of an electrical outer conductor for transmitting an electrical reference signal in the context of the signal transmission.

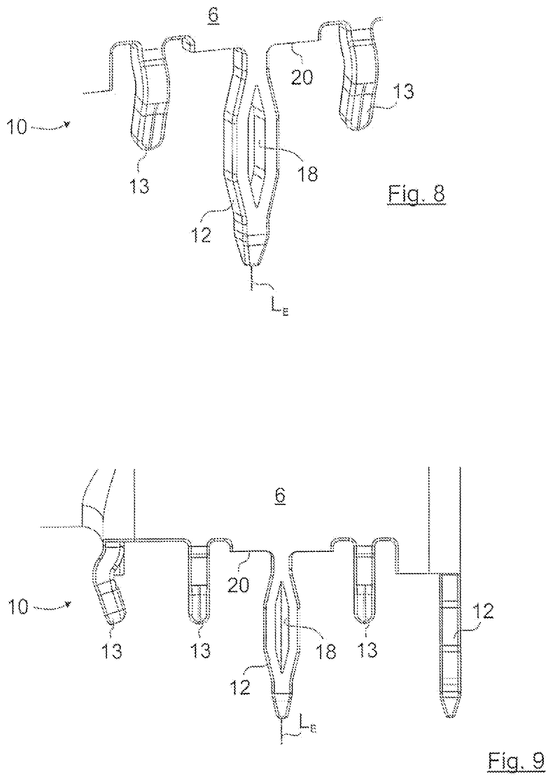

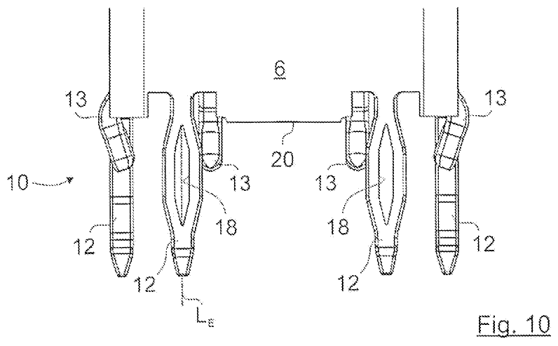

For the contacting of the electrical assembly or of the circuit board 3, it is provided that the contact elements 12, 13 are divided into two groups. A first group of the contact elements is formed as press-in pins 12 for an oversize fit in the metal-plated recesses 11 of the electrical assembly or circuit board 3. A second group of the contact elements is formed as resilient contact elements 13 for pressing into the metal-plated recesses 11 of the electrical assembly or circuit board 3. The press-in pins 12 may in particular have, along a section of their longitudinal axis L_{E}, an elastic deformation zone which is formed preferably by a central material recess 18 in the manner of a slot or the eye of a needle, as illustrated. (FIGS. 8, 9).

FIGS. 6 and 7 visualize the different pressing-in processes of the press-in pins 12 and of the resilient contact elements 13 into the metal-plated recesses 11. Whilst the pressing-in of the press-in pins 12 leads to a cold weld or cohesive, gas-tight connection, the fastening of the resilient contact elements 13 in the metal-plated recesses 11 occurs by elastic preloading of the resilient contact elements 13.

By virtue of the fact that resilient contact elements 13 are now also used in addition to the press-in pins 12, it is ultimately possible to realize a closer arrangement of contact elements 12, 13 whilst maintaining the same, or even achieving a reduced, pressing-in force. Damage to the electrical assembly or the electrical circuit board 3 as a result of the pressing-in process can thus be avoided. It is nevertheless possible for the shielding in the region of the second interface 10 to be improved as a result of the closer arrangement of the contact elements 12, 13.

As shown in FIG. 4, the inner-conductor contact elements 14 may have a deformation region 19 at their second end 16, similarly to the press-in pins 12. In this way, the inner-conductor contact elements 14 can also be pressed into the electrical assembly or into the electrical circuit board 3. It is however basically possible for any fastening technique to be provided between the inner-conductor contact elements 14 and the electrical assembly or the circuit board 3, for example also a soldering technique.

FIG. 5 shows, by way of example, the outer-conductor assembly 6 in a bottom plan view. It can be seen that the second interface 10 is formed on an end section, facing toward the electrical assembly or circuit board 3 at a face side, of a sleeve-shaped encircling wall 20 of the outer-conductor assembly 6, proceeding from which the contact elements 12, 13 extend in the direction of the electrical assembly or circuit board 3. Here, the contact elements 12, 13 are arranged so as to be distributed along the periphery of the sleeve-shaped encircling wall 20. In the exemplary embodiment, the contact elements 12, 13 are arranged so as to be distributed axially symmetrically and, in regions, equidistantly. Owing to the proposed use of press-in pins 12 and resilient contact elements 13, the maximum center-to-center spacing D (cf. FIG. 5) between the contact elements 12, 13 which are immediately adjacent along the periphery of the sleeve-shaped encircling wall 20 of the second interface 10 can be smaller than in the case of the exclusive use of press-in pins 12. Preferably, the center-to-center spacing 20 may correspond to one quarter of the wavelength of the signal frequency intended for the signal transmission with the electrical plug connector 2.

In the exemplary embodiment, the metal-plated recesses are formed as plated through-holes 11 in the electrical circuit board 3 (cf. in particular FIGS. 6 and 7). The metal-plated recesses may however also be formed as blind bores or depressions.

Preferably, the inner diameter of all of the metal-plated recesses 11 provided for contacting with the outer-conductor assembly 6 is identical in order to simplify the production of the electrical assembly or of the electrical circuit board 3.

FIG. 8 illustrates a detail of the second interface 10 of the outer-conductor assembly 6 on an enlarged scale. FIG. 9 furthermore shows a side view, and FIG. 10 shows a rear view, of the electrical plug connector 2 in the region of the second interface 10 of the outer-conductor assembly 6. The outer-conductor assembly 6 is preferably formed as a single piece, particularly preferably from a stamped and bent part. Here, aluminum bronze has proven to be a particularly advantageous material for forming the outer-conductor assembly 6.

The press-in pins 12, resilient contact elements 13 and/or metal-plated recesses 11 preferably have a circular or—as is the case in the exemplary embodiment—rectangular cross section (optionally with rounded corners).

For ease of insertion, it may be provided that the press-in pins 12 are designed to be longer than the resilient contact elements 13. The press-in pins 12 may furthermore, at their free ends, have an insertion section with reduced cross section, said cross section being widened in the region of the deformation zone (cf. in particular FIG. 8).

The press-in pins 12 are preferably formed so as to be coplanar with the encircling wall 20 of the outer-conductor assembly 6, and extend rectilinearly in the direction of the electrical assembly or circuit board 3. The resilient contact elements 13 are preferably angled and run so as not to be coplanar with the encircling wall 20 (cf. in particular FIGS. 9 and 10). Alternative configurations of the resilient contact elements 13 and/or press-in pins 12 may however also be provided.

### Operation

A principal object of the present invention is an outer-conductor assembly (6) for an electrical plug connector (2), the outer-conductor assembly (6) comprising a first interface (9) for electrically and mechanically contacting an outer conductor of a corresponding electrical counterpart plug connector; and a second interface (10) for electrically and mechanically contacting metal-plated recesses (11) of an electrical assembly; (3), and wherein the second interface (10) has a multiplicity of contact elements (12, 13) for the contacting of the electrical assembly (3); and wherein, a first group of the multiplicity of contact elements is formed as press-in pins (12) for an oversize fit in the metal-plated recesses (11) of the electrical assembly; (3), and a second group of the multiplicity of contact elements is formed as resilient contact elements (13) for insertion into the metal-plated recesses (11) of the electrical assembly (3).

A further object of the present invention is an outer-conductor assembly (6), and wherein the press-in pins (12) have, at least along a section of a longitudinal axis (L_{E}), an elastic deformation zone.

A further object of the present invention is an outer-conductor assembly (6), further comprising: a sleeve-shaped encircling wall of the outer-conductor assembly, the sleeve-shaped encircling wall having a face side; and the second interface is formed on an end section of the outer-conductor assembly, facing toward the electrical assembly; and the multiplicity of contact elements extend from the second interface in the direction of the electrical assembly.

A further object of the present invention is an outer-conductor assembly (6) wherein the multiplicity of contact elements (12, 13) are arranged in distributed fashion along a periphery of the sleeve-shaped encircling wall (20).

A further object of the present invention is an outer-conductor assembly (6) wherein at least one of the resilient contact elements (13) is, along a periphery of the sleeve-shaped encircling wall (20), and between two press-in pins (12).

A further object of the present invention is an outer-conductor assembly (6) and wherein the outer-conductor assembly (6) is formed as a single piece.

A further object of the present invention is an outer-conductor assembly (6) and wherein the outer-conductor assembly (6) is formed from aluminum bronze.

A further object of the present invention is an electrical plug connector (2) having an outer-conductor assembly (6) comprising: a first interface (9) for electrically and mechanically contacting an outer conductor of a corresponding electrical counterpart plug connector; and a second interface (10) for electrically and mechanically contacting metal-plated recesses (11) defined in an electrical assembly (3); and wherein the second interface (11) has a multiplicity of contact elements (12, 13) for the contacting of the electrical assembly (3); and wherein a first group of the contact elements (12, 13) is formed as press-in pins (12) for an oversize fit in the metal-plated recesses (11) of the electrical assembly (3); and a second group of the contact elements is formed as resilient contact elements (13) for insertion into the metal-plated recesses (11) defined in the electrical assembly (3).

A further object of the present invention is an electrical plug connector (2) and further comprising: an electrically insulating housing assembly (4) that has a mechanical interface (5) for connection of the electrical plug connector (2) to the corresponding counterpart plug connector; and wherein the outer-conductor assembly (6) is received in positively locking fashion in the housing assembly (4).

A further object of the present invention is an electrical plug connector (2) and further comprising: an inner-conductor contact element (14) which extends from a first end (15), within the first interface (9), to a second end (16), within the second interface (10), and through the outer-conductor assembly; and (6), wherein the inner-conductor contact element (14) is, at its first end (15), designed for the electrical and mechanical contacting of a corresponding inner conductor of the electrical counterpart plug connector and, the inner-conductor contact element is, at its second end (16), designed for the electrical and mechanical contacting of a corresponding inner conductor of the electrical assembly (3).

A further object of the present invention is an electrical plug connector (2) wherein a maximum center-to-center spacing (D) between the contact elements (12, 13) which are directly adjacent to one another along a periphery of the sleeve-shaped encircling wall (20) of the second interface (10) correspond to one quarter of a wavelength of a signal frequency intended for signal transmission with the electrical plug connector (2).

A further object of the present invention is an electrical connecting arrangement (1), having an electrical plug connector (2), comprising an outer-conductor assembly (6) that has, a first interface (9) for electrically and mechanically contacting an outer conductor of a corresponding electrical counterpart plug connector; and a second interface (10) for electrically and mechanically contacting metal-plated recesses (11) defined in an electrical assembly (3); and wherein the second interface (10) has a multiplicity of contact elements (12, 13) for the contacting of the electrical assembly (3); and wherein a first group of the multiplicity of contact elements (12, 13) is formed as press-in pins (12) for an oversize fit in the metal-plated recesses (11) of the electrical assembly (3); and a second group of the multiplicity of contact elements (13) is formed as resilient contact elements (13) for insertion into the metal-plated recesses (11) defined in the electrical assembly (3); and an electrical assembly (3), in particular an electrical circuit board (3), that defines plural metal-plated recesses (11) for electrically and mechanically contacting with the second interface (10) of the outer-conductor assembly (6) of the electrical plug connector (2).

A further object of the present invention is an electrical connecting arrangement (1) wherein the metal-plated recesses (11) are formed as plated through-holes (11) and/or blind bores in the electrical assembly, in particular in the electrical circuit board (3).

A further object of the present invention is an electrical connecting arrangement (1) wherein the resilient contact elements (13) make contact radially under mechanical preload with the metal-plated recesses (11) at an inner surface thereof when the resilient contact elements (13) are inserted into the metal-plated recesses (11).

A further object of the present invention is an electrical connecting arrangement (1) wherein an outer diameter of the resilient contact elements (13) is smaller than an inner diameter of the metal-plated recesses (11).

A further object of the present invention is an outer-conductor assembly (6) wherein the elastic deformation zone is a central material recess (18).

A further object of the present invention is an outer-conductor assembly (6) wherein the multiplicity of contact elements (12, 13) are arranged in along a periphery of the sleeve-shaped encircling wall (20).

A further object of the present invention is an outer-conductor assembly (6) wherein the multiplicity of contact elements (12, 13) are arranged in equidistantly distributed fashion, along the periphery of the sleeve-shaped encircling wall (20).

A still further object of the present invention is an outer-conductor assembly (6) wherein the outer-conductor assembly (6) is a stamped and bent part.

An even still further object of the present invention is an outer-conductor assembly (6) wherein the press-in pins (12) are arranged along a periphery of the sleeve-shaped encircling wall (20).

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. An outer-conductor assembly for an electrical plug connector, the outer-conductor assembly comprising:
a first interface for electrically and mechanically contacting an outer conductor of a corresponding electrical counterpart plug connector; and
a second interface for electrically and mechanically contacting metal-plated recesses of an electrical assembly;
and wherein the second interface has a multiplicity of contact elements for the contacting of the electrical assembly; and wherein
a first group of the multiplicity of contact elements is formed as press-in pins for an oversize fit in the metal-plated recesses of the electrical assembly; and
a second group of the multiplicity of contact elements is formed as resilient contact elements for insertion into the metal-plated recesses of the electrical assembly.

2. The outer-conductor assembly as claimed in claim 1, and wherein the press-in pins have, at least along a section of a longitudinal axis (L_{E}), an elastic deformation zone.

3. The outer-conductor assembly as claimed in claim 1 and further comprising:
a sleeve-shaped encircling wall of the outer-conductor assembly, the sleeve-shaped encircling wall having a face side; and
the second interface is formed on an end section of the outer-conductor assembly, facing toward the electrical assembly; and
the multiplicity of contact elements extend from the second interface in the direction of the electrical assembly.

4. The outer-conductor assembly as claimed in claim 3 and wherein the multiplicity of contact elements are arranged in distributed fashion along a periphery of the sleeve-shaped encircling wall.

5. The outer-conductor assembly as claimed in claim 3 and wherein at least one of the resilient contact elements is, along a periphery of the sleeve-shaped encircling wall and between two press-in pins.

6. The outer-conductor assembly as claimed in claim 1 and wherein the outer-conductor assembly is formed as a single piece.

7. The outer-conductor assembly as claimed in claim 1 and wherein the outer-conductor assembly is formed from aluminum bronze.

8. An electrical plug connector having an outer-conductor assembly comprising:
a first interface for electrically and mechanically contacting an outer conductor of a corresponding electrical counterpart plug connector; and
a second interface for electrically and mechanically contacting metal-plated recesses defined in an electrical assembly;
and wherein the second interface has a multiplicity of contact elements for the contacting of the electrical assembly; and wherein
a first group of the contact elements is formed as press-in pins for an oversize fit in the metal-plated recesses of the electrical assembly; and
a second group of the contact elements is formed as resilient contact elements for insertion into the metal-plated recesses defined in the electrical assembly.

9. The electrical plug connector as claimed in claim 8 and further comprising:
an electrically insulating housing assembly that has a mechanical interface for connection of the electrical plug connector to the corresponding counterpart plug connector; and wherein
the outer-conductor assembly is received in positively locking fashion in the housing assembly.

10. The electrical plug connector as claimed in claim 9 and further comprising:
an inner-conductor contact element which extends from a first end within the first interface, to a second end within the second interface, and through the outer-conductor assembly; and wherein
the inner-conductor contact element is, at its first end, designed for the electrical and mechanical contacting of a corresponding inner conductor of the electrical counterpart plug connector and, the inner-conductor contact element is, at its second end, designed for the electrical and mechanical contacting of a corresponding inner conductor of the electrical assembly.

11. The electrical plug connector as claimed in claim 8 and wherein a maximum center-to-center spacing (D) between the contact elements which are adjacent to one another along a periphery of the sleeve-shaped encircling wall of the second interface correspond to one quarter of a wavelength of a signal frequency intended for signal transmission with the electrical plug connector.

12. An electrical connecting arrangement, having an electrical plug connector, comprising:
an outer-conductor assembly that has,
a first interface for electrically and mechanically contacting an outer conductor of a corresponding electrical counterpart plug connector; and
a second interface for electrically and mechanically contacting metal-plated recesses defined in an electrical assembly;
and wherein the second interface has a multiplicity of contact elements for the contacting of the electrical assembly; and wherein
a first group of the multiplicity of contact elements is formed as press-in pins for an oversize fit in the metal-plated recesses of the electrical assembly; and
a second group of the multiplicity of contact elements is formed as resilient contact elements for insertion into the metal-plated recesses defined in the electrical assembly; and
an electrical assembly, in particular an electrical circuit board that defines plural metal-plated recesses for electrically and mechanically contacting with the second interface of the outer-conductor assembly of the electrical plug connector.

13. The electrical connecting arrangement as claimed in claim 12 and wherein the metal-plated recesses are formed as plated through-holes and/or blind bores in the electrical assembly.

14. The electrical connecting arrangement as claimed in claim 12 and wherein the resilient contact elements make contact radially under mechanical preload with the metal-plated recesses at an inner surface thereof when the resilient contact elements are inserted into the metal-plated recesses.

15. The electrical connecting arrangement as claimed in claim 12 and wherein an outer diameter of the resilient contact elements is smaller than an inner diameter of the metal-plated recesses.

16. The outer-conductor assembly as claimed in claim 2, and wherein the elastic deformation zone is a central material recess.

17. The outer-conductor assembly as claimed in claim 3 and wherein the contact elements are arranged in along a periphery of the sleeve-shaped encircling wall.

18. The outer-conductor assembly as claimed in claim 3 and wherein the contact elements are arranged in equidistantly distributed fashion, along the periphery of the sleeve-shaped encircling wall.

19. The outer-conductor assembly as claimed in claim 1 and wherein the outer-conductor assembly is a stamped and bent part.

20. The outer-conductor assembly as claimed in claim 3 and wherein the press-in pins are arranged along a periphery of the sleeve-shaped encircling wall.
